(19) United States
(12) Patent Application Publication
(10) Pub. No.: US 2013/0091840 A1
(43) Pub. Date: Apr. 18, 2013

(54) SHOCKWAVE-ACTUATED POWER DEVICE

(71) Applicants: Chang-Hsien Tai, Pingtung (TW); Shi-Wei Lo, Pingtung (TW); Yao-Nan Wang, Pingtung (TW)

(72) Inventors: Chang-Hsien Tai, Pingtung (TW); Shi-Wei Lo, Pingtung (TW); Yao-Nan Wang, Pingtung (TW)

(21) Appl. No.: 13/610,273

(22) Filed: Sep. 11, 2012

(30) Foreign Application Priority Data
Oct. 12, 2011 (TW) 100136933

(51) Int. Cl. F15B 21/12

(52) U.S. Cl. 60/532

(57) ABSTRACT

A shockwave-actuated power device includes a cylinder, a regulating module, and a piston assembly. The cylinder includes a chamber and a filling port in communication with the chamber. The regulating module includes first and second partitioning members and a driving member. The first and second partitioning members are received in the chamber, dividing the chamber into a high-pressure filling section, a shockwave train developing/actuating section, and a high-energy shockwave producing section located between the high-pressure filling section and the shockwave train developing/actuating section, with the filling port located in the high-pressure filling section. The driving member drives the first and second partitioning members to control communication between the high-pressure filling section, the high-energy shockwave producing section, and the shockwave train developing/actuating section. The piston assembly is movably received in the shockwave train developing/actuating section and drives a power output device.

### BACKGROUND OF THE INVENTION

1. Field of the Invention

The present invention relates to a power device and, more particularly, to a power device using a high pressure gas to produce high-energy shockwaves for actuating a piston.

2. Description of the Related Art

Most machines, such as vehicle engines and internal combustion engines, combust fossil fuels (such as gasoline or diesel) and convert the chemical energy into heat energy and mechanical energy to obtain sufficient propulsive power. However, the price of fossil fuels soars in recent years due to global energy consumption and due to the waste and greenhouse effect resulting from combustion of the fossil fuels. Thus, development in pollution-free substitutive power output devices is the most prominent issue in the modern industries.

Taiwan Patent No. 1327621 discloses a power device using a high pressure gas to actuate a piston for outputting power. Specifically, the power device provides a cylinder with high-pressure energy by using a high-pressure gas supply device. Through opening and closing of an inlet valve and an outlet valve, the high pressure gas enters or exits the cylinder to push the piston in the cylinder, which, in turn, causes rotation of a crank, completing power output operation.

However, the impact force generated by the high pressure gas gradually decreases as the pressure of the gas decreases, such that a larger amount of high pressure gas must be outputted to accumulate the impact force for driving the crank through the piston for power output purposes. Thus, more external energy is required to provide the initial energy for producing a large amount of high pressure gas, increasing the costs for power production. Furthermore, accumulation of the impact force of the larger amount of high pressure gas takes a longer time, leading to inefficiency in the power producing procedure.

Furthermore, even though the impact force of the larger amount of high pressure gas can be accumulated on the surface of the piston, the one-time impact force from the high pressure gas is far less than the propulsive force obtained from a full combustion process of conventional fossil fuels. Namely, the propulsive force outputted by the piston can not be increased, and the power production effect and the power output efficiency are reduced, failing to provide better power output in a short period of time for driving various power-driven machines.

Thus, a need exists for a low-cost shockwave-actuated power device that increases the power output effect by a high energy density approach to solve the above disadvantages.

### SUMMARY OF THE INVENTION

An objective of the present invention is to provide a shockwave-actuated power device that generates a high-energy shockwave train through a high pressure gas to push a piston at high speed while enhancing the production effect and the output efficiency of the propulsive power.

Another objective of the present invention is to provide a shockwave-actuated power device that produces super-pressure multiplied impact energy through repeated accumulation of positive shockwaves and reflective shockwaves, reducing the initial energy loss and reducing the costs for the power yield.

A further objective of the present invention is to provide a shockwave-actuated power device that can replace conventional propulsive power generated by combusting conventional fossil fuels with a high-energy shockwave train generated by a high pressure gas, reducing the environmental load and protecting the environment.

Still another objective of the present invention is to provide a shockwave-actuated power device that can increase the energy-multiplying speed of the high-energy shockwaves, providing extreme power yield and power output in a limited period of time.

The present invention fulfills the above objectives by providing, in a first aspect, a shockwave-actuated power device including a cylinder, a regulating module, and a piston assembly. The cylinder includes a chamber and a filling port in communication with the chamber. The regulating module includes first and second partitioning members and a driving member. The first and second partitioning members are received in the chamber, dividing the chamber into a high-pressure filling section, a high-energy shockwave producing section, and a shockwave train developing/actuating section, with the high-energy shockwave producing section located between the high-pressure filling section and the shockwave train developing/actuating section, with the filling port located in the high-pressure filling section. The driving member drives the first and second partitioning members to control communication between the high-pressure filling section, the high-energy shockwave producing section, and the shockwave train developing/actuating section. The piston assembly is movably received in the shockwave train developing/actuating section and drives a power output device.

Preferably, the cylinder further includes a gas outlet port in communication with the shockwave train developing/actuating section. The gas outlet port discharges gas in the shockwave train developing/actuating section.

Preferably, the shockwave-actuated power device further includes a gas guiding tube in communication with the chamber. Two ends of the gas guiding tube respectively form a gas guiding port and a gas inlet port, with the gas guiding port adapted to guide the gas at a side of the piston assembly out of the chamber, with the gas inlet port adapted to fill the gas in the gas guiding tube into another side of the piston assembly.

Preferably, each of the first and second partitioning members includes at least one opening. The at least one opening of the first partitioning member is misaligned from the at least one opening of the second partitioning member. In an example, the first partitioning member includes a plurality of openings, and the second partitioning member includes an opening. The opening of the second partitioning member is misaligned from the plurality of openings of the first partitioning member and located between two adjacent openings of the first partitioning member.

Preferably, the piston assembly includes a piston and a connecting rod having an end connected to the piston. The other end of the connecting rod extends in a longitudinal direction of the cylinder through an end wall of the cylinder and is connected to the power output device.

The piston divides the shockwave train developing/actuating section into an actuation section and a gas refilling section. The actuation section is in communication with the gas guiding port of the gas guiding tube. The gas refilling section is in communication with the gas inlet port of the gas guiding tube and the gas outlet port of the cylinder.

Preferably, the power output device includes a crankshaft, two smaller flywheels and two larger flywheels. Each smaller flywheel is connected to one of two ends of the crankshaft and drives one of the larger flywheels to rotate.

In a second aspect, a shockwave-actuated power device includes a cylinder, two regulating modules, and two piston assemblies. The cylinder includes a chamber and a filling port in communication with the chamber. Each regulating module includes first and second partitioning members and a driving member. The first and second partitioning members of each regulating module is received in the chamber, dividing the chamber into a high-pressure filling section, two high-energy shockwave producing sections, and two shockwave train developing/actuating sections, with each of the two high-energy shockwave producing sections located between the high-pressure filling section and one of the two shockwave train developing/actuating sections, with the filling port located in the high-pressure filling section. The driving members of the two regulating modules drive the first and second partitioning members to control communication between the high-pressure filling section, the two high-energy shockwave producing sections, and the two shockwave train developing/actuating sections. Each piston assembly is movably received in one of the two shockwave train developing/actuating sections. The piston assemblies drive a power output device.

In a third aspect, a shockwave-actuated power device includes two cylinders, four regulating modules, and four piston assemblies. Each cylinder includes a chamber and a filling port in communication with the chamber. Each regulating module includes first and second partitioning members and a driving member. The first and second partitioning members of each two of the four regulating modules are received in the chamber of one of the cylinders, dividing the chamber of each cylinder into a high-pressure filling section, two high-energy shockwave producing sections, and two shockwave train developing/actuating sections, with each of the two high-energy shockwave producing sections located between the high-pressure filling section and one of the two shockwave train developing/actuating sections, with the filling port located in the high-pressure filling section. The driving members of each two of the four regulating modules drive the first and second partitioning members to control communication between the high-pressure filling section, the two high-energy shockwave producing sections, and the two shockwave train developing/actuating sections. Each piston assembly is movably received in one of the shockwave train developing/actuating sections. The piston assemblies drive a power output device.

Preferably, the high-pressure filling sections of the two cylinders are connected to a common high pressure tank. The high-energy shockwave producing section of each cylinder is connected to the common high pressure tank by a filling pipe.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a schematic structural view of a shockwave-actuated power device according to the present invention, with both of first and partitioning members in a closed position.

FIG. 2 shows a view similar to FIG. 1, with the first partitioning member in an open position, and with the second partitioning member in the closed position.

FIG. 3 shows a view similar to FIG. 2, with both of the first and second partitioning members in the closed position.

FIG. 4 shows a view similar to FIG. 3, with the first partitioning member in the closed position, with the second partitioning member in the open position, and with a piston moved.

FIG. 5 shows a view similar to FIG. 4, with both of the first and second partitioning member in the closed position, with the piston moved in a reverse direction.

FIG. 6 shows a schematic structural view of another example of the shockwave-actuated power device according to the present invention.

FIG. 7 shows a schematic structural view of a further example of the shockwave-actuated power device according to the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

A shockwave-actuated power device according to the present invention uses a high pressure gas as a power source to produce a propulsive power for use in a power-driven mechanism, such as a vehicle, according to the user needs, wherein the high pressure gas has stable physical thermal properties and can be easily stored relative to heat energy.

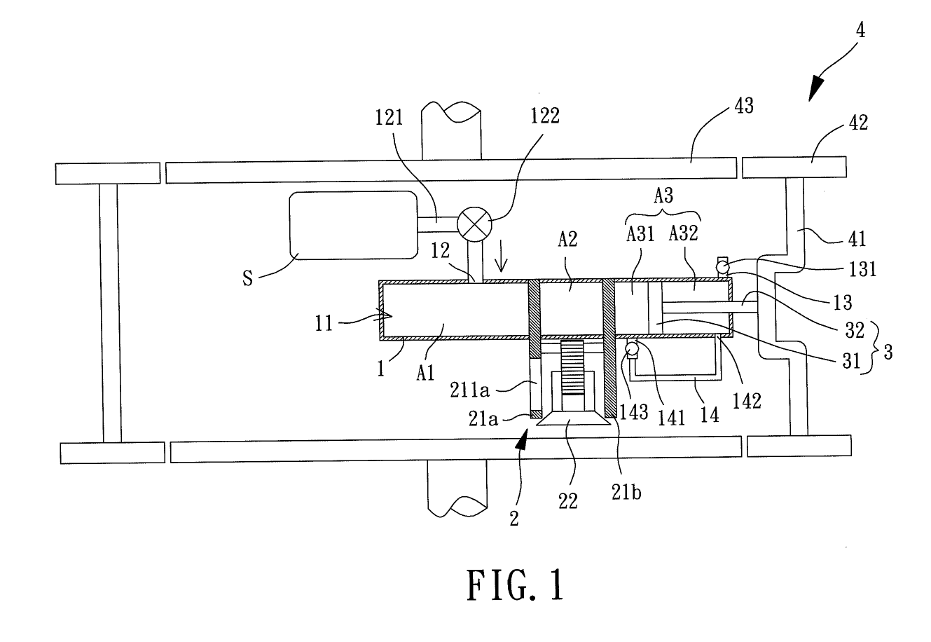

FIG. 1 shows an embodiment of a shockwave-actuated power device according to the present invention. The shockwave-actuated power device includes at lease one cylinder 1, at least one regulating module 2, and at least one piston assembly 3. Operation of the present invention will be described with reference to the simplest arrangement having a cylinder 1, a regulating module 2, and a piston assembly 3.

The cylinder 1 includes a chamber 11 allowing a high pressure gas to produce repeated impact in the chamber 11 to gradually accumulate the shockwave energy. The shape and size of the chamber 11 allows the high pressure gas to produce repeated impact such that the piston cylinder 3 can move in a longitudinal direction of the cylinder 1. In this embodiment, the cylinder 1 is in the form of a hollow cylindrical member having a length suitable for increasing the super pressure from the repeated impact of the high pressure gas, generating higher shockwave impact energy through gradual accumulation to increase the power output effect.

The cylinder 1 further includes a filling port 12 in communication with the chamber 11. The high pressure gas can be filled into the chamber 11 through the filling port 12. In this embodiment, the filling port 12 is connected to a filling pipe 121 connected to a high pressure tank S receiving the high pressure gas. The high pressure tank S supplies the high pressure gas and allows continuous movement. Furthermore, a valve 122 can be provided to control opening and closing of the filling port 12.

The cylinder 1 further includes a gas outlet port 13 in communication with the chamber 11 to allow discharge of the gas in the chamber 11. In this embodiment, a valve, particularly a pressure control valve, is provided to the gas outlet port 13 that is located adjacent to an end of the piston assembly 3. When the piston assembly 3 reaches a bottom dead center, the gas at a normal pressure can be discharged via the gas outlet port 13. The cylinder 1 further includes a gas guiding tube 14 in communication with the chamber 11. Two ends of the guiding tube 14 respectively form a gas guiding port 141 and a gas inlet port 142. The gas guiding port 141 guides gas at a side of the piston assembly 3. The gas in the gas guiding tube 14 can be filled to the other side of the piston assembly 3 via the gas inlet port 142. Preferably, a valve 143, particularly a pressure control valve, is provided in the gas guiding port 141, such that compressed gas can be guided out of the chamber 11 to the gas inlet port 142 via the gas guiding port 141 when the piston assembly 3 returns.

The regulating module 2 includes a first partitioning member 21a, a second partitioning member 21b, and a driving member 22. The first and second partitioning members 21a and 21b are received in the chamber 11 of the cylinder 1 to separate the chamber 11 into a high-pressure filling section A1, a high-energy shockwave producing section A2, and a high-energy shockwave producing section A3, with the high-energy shockwave producing section A2 located between the high-pressure filling section A1 and the shockwave train developing/actuating section A3, with the high-pressure filling section A1 being in communication with the filling port 12. The high pressure gas is filled into the high-pressure filling section A1 to create a pressure difference between the high-pressure filling section A1 and the high-energy shockwave producing section A2. The piston assembly 3 is received in the shockwave train developing/actuating section A3. Thus, when the high pressure is momentarily released and produces a positive shockwave, the pressure is increased to a super pressure after repeated impact by the positive shockwaves and the reflective shockwaves in the high-energy shockwave producing section A2. A shockwave pattern in the form of a Mach train is developed in the shockwave train developing/actuating section A3 to directly impact and actuates the piston assembly 3 in the shockwave train developing/actuating section A3, providing a propulsive power.

In this embodiment, each of the first and second partitioning members 21a and 21b is in the form of a rotary disc connected to the driving member 22, forming the regulating module 2. The driving member 22 can continuously drive the first and second partitioning members 21a and 21b to rotate for effectively controlling communication between the high-pressure filling section A1, the high-energy shockwave producing section A2, and the shockwave train developing/actuating section A3. Specifically, through control of the regulating module 2, the high-pressure filling section A1, the high-energy shockwave producing section A2, and the shockwave train developing/actuating section A3 can be in communication with each other to allow the high pressure gas to produce the positive shockwave in the high-energy shockwave producing section A2. Furthermore, after repeated interaction between the positive shockwave and the reflective shockwave to increase the pressure to the super pressure, the flow field of the shockwave train is produced. Then, the gas with high-energy shockwave impacts the piston assembly 3 in the shockwave train developing/actuating section A3. The regulating module 2 is not limited to a partitioning board, a rotary disc, or any provision providing opening and closing functions, which can be appreciated by one skilled in the art.

With reference to FIG. 1, each of the first and second partitioning members 21a and 21b has at least one opening 211, 211b having a diameter preferably equal to an inner diameter of the cylinder 1. The openings 211a and 211b of the first and second partitioning members 21a and 21b control communication between the high-pressure filling section A1, the high-energy shockwave producing section A2, and the shockwave train developing/actuating section A3. In this embodiment, each of the first and second partitioning members 21a and 21b includes an opening 211a, 211b. Preferably, the opening 211a of the first partitioning member 21a is misaligned with the opening 211b of the second partitioning member 21b. In another example, the first partitioning member 21a includes a plurality of openings 211a, and the second partitioning member 21b includes only one opening 211b that is located between two adjacent openings 21a of the first partitioning member 21a. Thus, when the driving member 22 drives the first and second partitioning members 21a and 21b to rotate, synchronous opening of the first and second partitioning members 21a and 21b can be avoided, assuring that the high-energy shockwave in the high-energy shockwave producing section A2 can develop into the flow field of the shockwave, providing strong impact to the piston assembly 3 in the shockwave train developing/actuating section A3.

The driving member 22 can be any driving mechanism, such as a motor, which can be appreciated by one skilled in the art. The driving member 22 drives the first and second partitioning members 21a and 21b to rotate. Through alignment or misalignment between the openings 211a and 211b of the first and second partitioning members 21a and 21b, the high-pressure filling section A1, the high-energy shockwave producing section A2, and the shockwave train developing/actuating section A3 can be controlled to be isolated from or in communication with each other.

With reference to FIG. 1, the piston assembly 3 is movably received in the chamber 11 of the cylinder 1 and preferably received in the shockwave train developing/actuating section A3. In this embodiment, the piston assembly 3 includes a piston 31 and a connecting rod 32. An end of the connecting rod 32 is connected to the piston 31. The other end of the connecting rod 32 extends in the longitudinal direction of the cylinder 1 through an end wall of the cylinder 1 and is connected to a power output device 4. The piston 31 reciprocates in the shockwave train developing/actuating section A3 to drive the power output device 4. Specifically, the piston 31 divides the shockwave train developing/actuating section A3 into an actuation section A31 and a gas refilling section A32, with the actuation section A31 defined between the second partitioning member 21b and the piston 31. Preferably, the actuation section A31 is in communication with the gas guiding port 141 of the guiding tube 14, and the gas refilling section A32 is in communication with the gas outlet port 13 of the cylinder 1. Thus, the residual gas in the actuation section A31 can be guided into the gas refilling section A32 via the gas guiding port 141 and the gas inlet port 142 and then discharged via the gas outlet port 13.

The power output device 4 includes a crankshaft 41, two smaller flywheels 42, and two larger flywheels 43. Each of two ends of the crankshaft 41 is connected to one of the smaller flywheels 42, with each smaller flywheel 42 driving a larger flywheel 43. In this embodiment, the crankshaft 41 is preferably connected to and driven by the other end of the connecting rod 22. Preferably, each of the smaller and larger flywheels 42 and 43 includes a toothed portion, with the toothed portion of each smaller flywheel 42 meshed with the toothed portion of one of the larger flywheels 43. Thus, when the crankshaft 41 drives the smaller flywheels 42 to rotate, the larger flywheels 43 are also driven to rotate, achieving power transmission. The power output device 4 can be a mechanism used in vehicles or the like, the structure and operation of which can be appreciated by one skilled in the art. However, the power output device 4 is not limited to the example shown. Namely, the power output device 4 can be used to drive any machines.

In power output operation of the shockwave-actuated power device according to the present invention, the first and second partitioning members 21 a and 21 b are not opened, as shown in FIG. 1. The high pressure gas is filled via the filling port 12 into the high-pressure filling section A1 to create a pressure difference between the high-pressure filling section A1 and the high-energy shockwave producing section A2. In this embodiment, the valve 122 connected to the filling port 12 is initially opened to guide the high pressure gas in the high pressure tank S into the high-pressure filling section Al via the filling pipe 121. Thus, the piston assembly 3 is actuated to produce continuous power through repeated filling of the high pressure gas from the high pressure tank S.

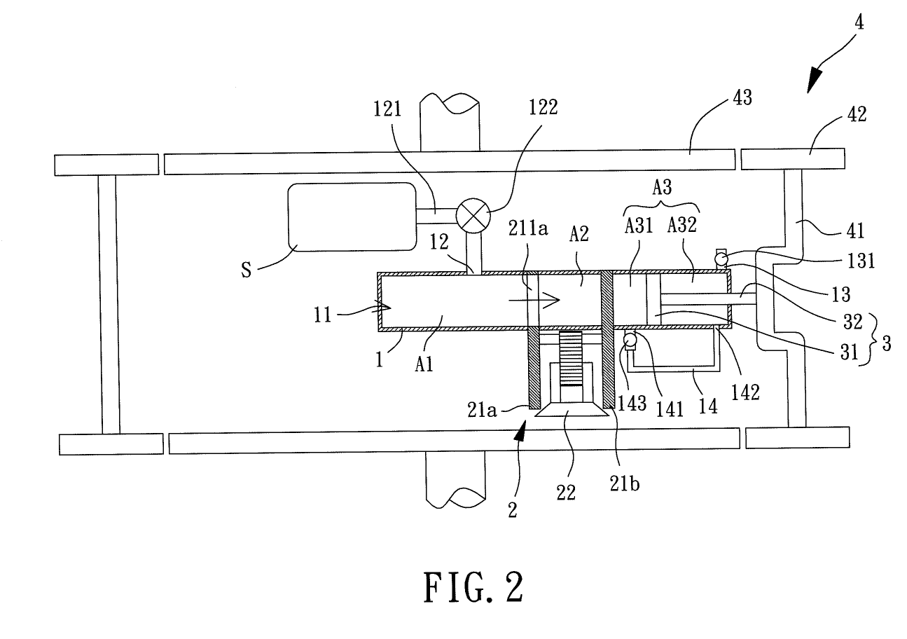

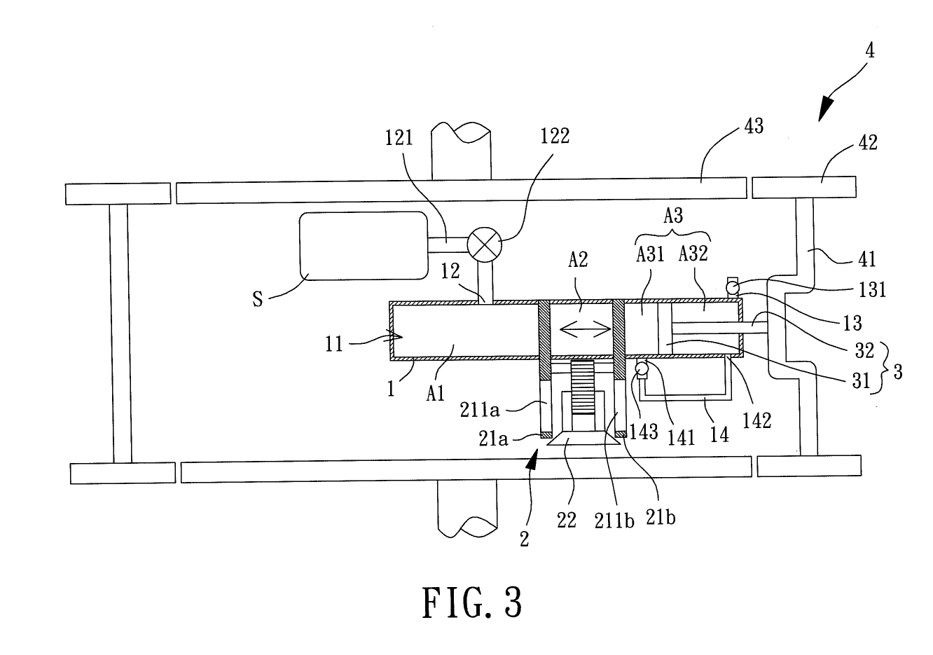

With reference to FIGS. 2 and 3, the driving member 22 drives the first and second partitioning members 21a and 21b to a position in which the first partitioning member 21a is in an open state and the second partitioning member 21b is in a closed state. Thus, the high pressure gas filled in the high-pressure filling section A1 produces a positive shockwave that develops in the high-energy shockwave producing section A2. The first partitioning member 21a is instantly closed such that both first and second partitioning members 21a and 21b are closed. Thus, the positive shockwave and the reflective shockwave reciprocatingly impact each other in the high-energy shockwave producing section A2 to increase the operative super pressure value (see FIG. 3).

Specifically, a first positive shockwave is produced at the impact moment of the high pressure. The first positive shockwave rapidly passes through the opening 211a of the first partitioning member 21a to the downstream portion of the high-energy shockwave producing section A2. A first reflective shockwave is produced as soon as the first positive shockwave impacts the second partitioning member 21b. The first partitioning member 21a is reopened when the first reflective shockwave is going to impact the first partitioning member 21a. The procedure shown in FIG. 2 is repeated. Namely, high pressure gas is filled into the high-pressure filling section A1 again to produce a second positive shockwave. The second positive shockwave and the first reflective shockwave produce an energy overlapping effect, forming a second synthetic positive shockwave. A second reflective shockwave is produced as soon as the second synthetic positive shockwave impacts the second partitioning member 21b. The first partitioning member 21a is reopened when the second reflective shockwave is going to impact the first partitioning member 21a. Then, high pressure gas is filled into the high-pressure. filling section A1 again to produce a third positive shockwave. The third positive shockwave and the second reflective shockwave produce an energy overlapping effect, forming a third synthetic positive shockwave. After repeating the procedure several times, the shockwave train generated by the high pressure gas reciprocates in the high-energy shockwave producing section A2, gradually increasing the pressure to the super pressure. Thus, the shockwave pressure can be multiplied in the high-energy shockwave producing section A2 (FIG. 3).

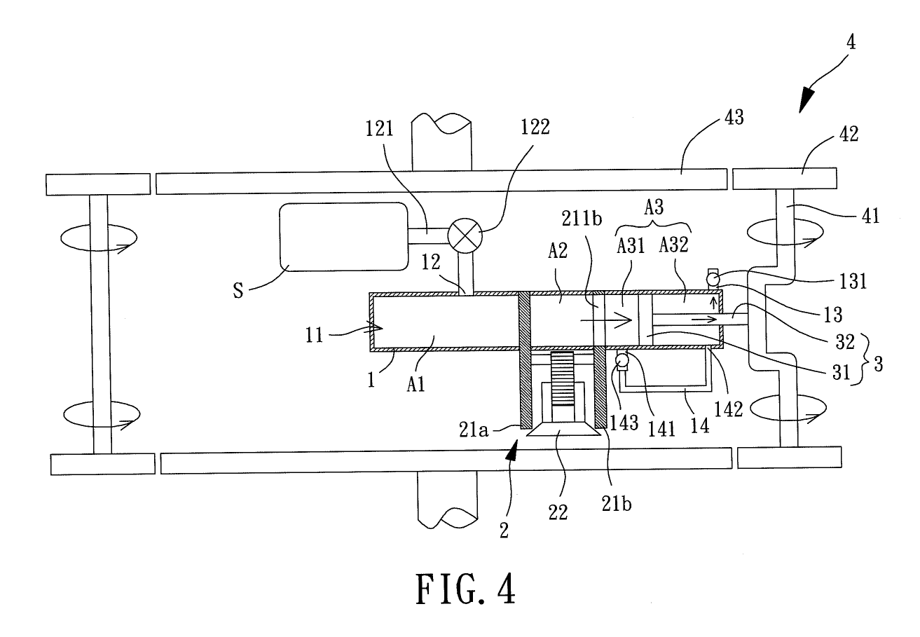

With reference to FIG. 4, after sufficient shockwave energy is generated in the high-energy shockwave producing section A2, the driving member 22 rotates the first and second partitioning members 21a and 21b again to another position in which the first partitioning member 21a is in a closed state and the second partitioning member 21b is in an open state, avoiding reduction of the super-pressure value of the shockwave resulting from adverse affect to the high-energy shockwave in the high-energy shockwave producing section A2 by the high pressure gas source. Thus, the high-energy positive shockwave in the high-energy shockwave producing section A2 passes through the opening 211b of the second partitioning member 21b and develops into a shockwave train in the shockwave train developing/actuation section A3 to actuate the piston assembly 3, providing a propulsive power. The power is outputted to the smaller flywheels 42 through the connecting rod 22 and the crankshaft 41 and then to a desired place through the large flywheels 43. Accordingly, the shockwave-actuated power device according to the present invention forcibly drives the piston assembly 3 to produce the propulsive power, and the power is outputted through the power output device 4. Still referring to FIG. 4, when the piston assembly 3 moves from the gas refilling section A32 to the actuation section A31, the valve 131 at the gas outlet port 13 is opened to allow exhaustion of the residual gas via the gas outlet port 13, reducing the resistance to movement of the piston assembly 3 and increasing the moving efficiency of the piston assembly 3.

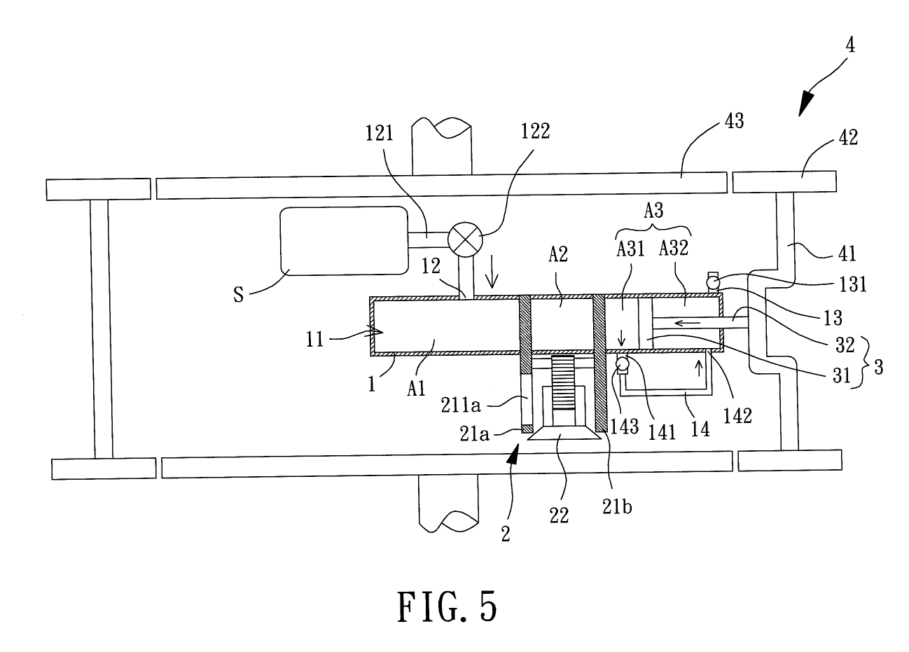

With reference to FIG. 5, due to the moment of inertia of the power output device 4, the piston assembly 3 is moved towards the actuation section A31 to its initial position. The valve 143 at the gas guiding port 141 is opened after the residual gas in the actuation section A31 is gradually compressed such that the residual gas in the actuation section A31 can be guided through the gas guiding port 141 of the guiding tube 14 and then guided into the gas refilling section A31 via the gas inlet port 142. When the piston assembly 3 moves towards the gas refilling section A31, the exhaustion operation shown in FIG. 4 is repeated. Thus, resistance to the impact from the high-energy positive shockwave in the high-energy shockwave producing section A2 moving towards the shockwave train developing/actuating section A3 can be reduced, maintaining the impact force of the high-energy shockwave and providing a larger propulsive power while actuating the piston assembly 3.

As mentioned above, the main features of the shockwave-actuated power device according to the present invention are that by providing the first and second partitioning members 21a and 21b to separate the high-pressure filling section A1, the high-energy shockwave producing section A2, and the shockwave train developing/actuating section A3, with the high-energy shockwave producing section A2 located between the high-pressure filling section A1 and the shockwave train developing/actuating section A3, the high pressure gas filled into the high-pressure filling section A1 can directly move towards the relatively low-pressure high-energy shockwave producing section A2 while the first partitioning member 21a is open, and a shockwave is momentarily produced in the high-energy shockwave producing section A2. Furthermore, during repeated opening and closing of the first partitioning member 21a, a plurality of shockwaves can be produced by the high pressure gas and forced to reciprocate in the high-energy shockwave producing section A2, gradually increasing the energy overlapping effect. The resultant impact energy is a multiple of the initial shockwave energy to actuate the piston assembly 3 and produces a strong propulsive power, increasing the power production effect and the power output efficiency.

Furthermore, at the moment the second partitioning member 21b is also opened, high-energy shockwave leaves the high-energy shockwave producing section A2 and impacts the shockwave train developing/actuating section A3 at high speed, actuating the piston assembly 3 in the shockwave train developing/actuating section A3. Further, the power output device 4 is driven while the piston assembly 3 moves towards the gas refilling section A32, providing strong power to a desired place. Thus, the power output operation can be accomplished by a smaller initial energy, saving the loss of external energy source and reducing the costs. Thus, the shockwave-actuated power device according to the present invention can replace the propulsive power obtained from conventional fossil fuels or fuel cells. The power output effect can be enhanced by high-speed high-energy shockwave, reducing the environmental load and protecting the environment.

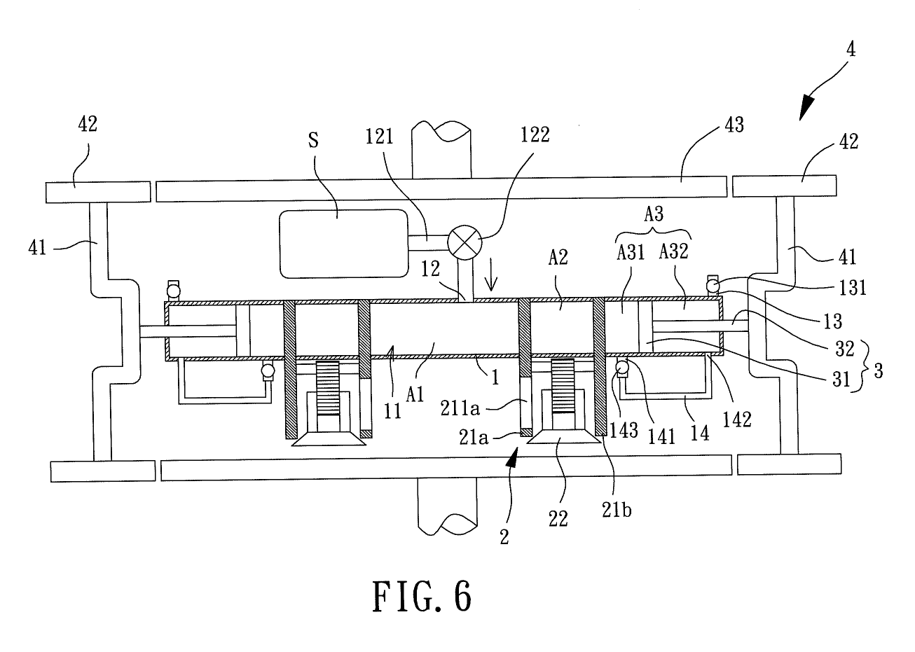

FIG. 6 shows another embodiment of the present invention. In this embodiment, the shockwave-actuated power device includes a cylinder 1, two regulating modules 2, and two piston assemblies 3. The regulating modules 2 are located on two sides of the cylinder 1. The piston assemblies 3 are located on two sides of the cylinder 1. Similar to the embodiment shown in FIG. 1, the cylinder 1 in this embodiment includes a filling port 12, a gas outlet port 13, and a guiding tube 14, providing the same effect as that in the first embodiment. In this embodiment, a high-pressure filling section A1 is located between the regulating modules 2 and located between two high-energy shockwave producing sections A2, with each high-energy shockwave producing section A2 located between one of two shockwave train developing/actuating sections A3 and the high-pressure filling section A1.

After the high-pressure filling section A1 is filled with the high pressure gas, each regulating module 2 is activated to accumulate shockwave energy in each high-energy shockwave producing section A2, actuating the piston assembly 3 in each shockwave train developing/actuating section A3 to provide a strong propulsive power, which is similar to the embodiment of FIG. 1. The crankshafts 41 are driven by the piston assemblies 3 to rotate the smaller flywheels 42 and the larger flywheels 43, increasing the power production effect and the power output efficiency.

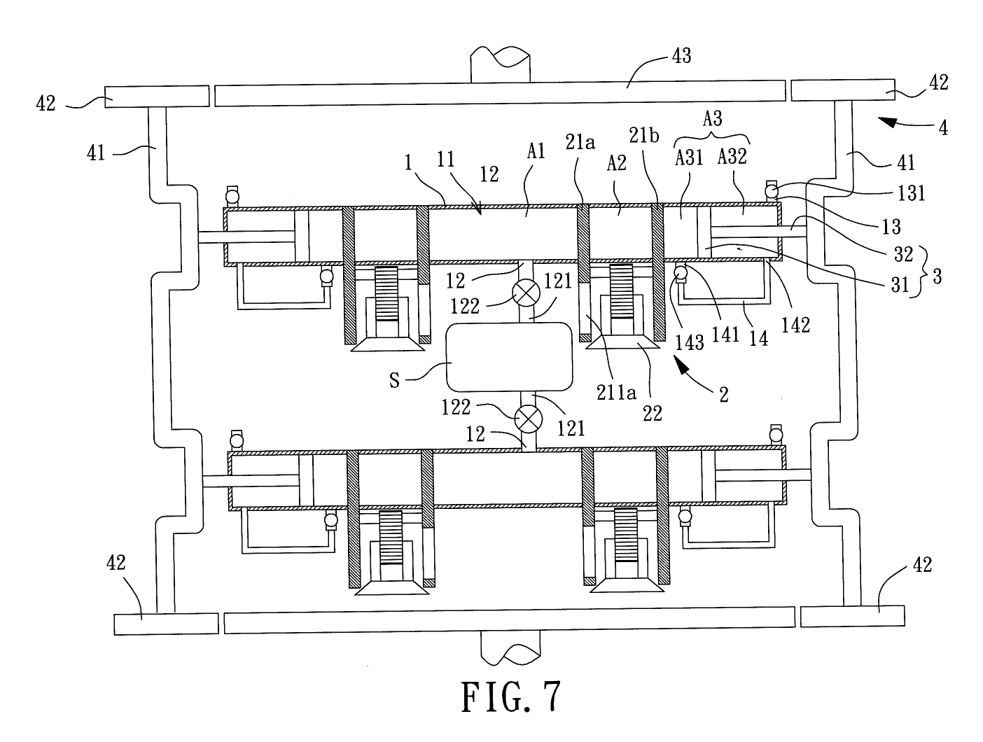

FIG. 7 shows a further embodiment of the present invention. In this embodiment, the shockwave-actuated power device includes two cylinders 1, four regulating modules 2, and four piston assemblies 3. Each two regulating modules 2 are located on two sides of one of the cylinders 1. Each of two piston assemblies 3 are located on two sides of one of the cylinders 1. Similar to the embodiment shown in FIG. 1, each cylinder 1 in this embodiment includes a filling port 12, a gas outlet port 13, and a guiding tube 14, providing the same effect as that in the first embodiment. In this embodiment, the high-pressure filling section A1 in each cylinder 1 is connected by a filling pipe 121 and a valve 122 to a common high pressure tank S that synchronously fills the high pressure gas into the high-pressure filling sections A1 in the cylinders 1.

After each high-pressure filling section A1 is filled with the high pressure gas, each regulating module 2 is activated to accumulate shockwave energy in each high-energy shockwave producing section A2, actuating the piston assembly 3 in each shockwave train developing/actuating section A3 to provide a strong propulsive power, which is similar to the above embodiments. The crankshafts 41 are driven by the piston assemblies 3 to rotate the smaller flywheels 42 and the larger flywheels 43, outputting the power. By providing multiple cylinders 1, the energy-overlapping speed in each high-energy shockwave producing section A2 can be increased to synchronously actuate the piston assemblies 3 in the shockwave train developing/actuating sections A3 by strong, high-energy shockwaves. The shockwave-actuated power device according to the present invention can maximize the power production effect and the power output efficiency in a limited period of time.

By using the high pressure gas to produce high-energy shockwave, the shockwave-actuated power device can obtain strong impact energy through accumulation of shockwave energy, and the high-energy shockwave rapidly impacts the shockwave train developing/actuating section A3 to actuate the piston assembly 3 in the shockwave train developing/actuating section A3, driving the power output device 4 for outputting power operation, increasing the power production effect and the power output efficiency.

The power output operation can be achieved with a smaller initial energy by using the shockwave-actuated power device according to the present invention, saving the loss of external energy source to reduce the costs in the power output procedure. The propulsive power obtained from conventional fossil fuels or fuel cells can be replaced with high-energy shockwaves to avoid air pollution resulting from combustion of conventional fossil fuels, reducing the environmental load and protecting the environment while outputting power.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A shockwave-actuated power device comprising:
a cylinder including a chamber and a filling port in communication with the chamber;
a regulating module including first and second partitioning members and a driving member, with the first and second partitioning members received in the chamber, dividing the chamber into a high-pressure filling section, a high-energy shockwave producing section, and a shockwave train developing/actuating section, with the high-energy shockwave producing section located between the high-pressure filling section and the shockwave train developing/actuating section, with the filling port located in the high-pressure filling section, with the driving member driving the first and second partitioning members to control communication between the high-pressure filling section, the high-energy shockwave producing section, and the shockwave train developing/actuating section; and
a piston assembly movably received in the shockwave train developing/actuating section, with the piston assembly driving a power output device.

2. The shockwave-actuated power device as claimed in claim 1, with the cylinder further including a gas outlet port in communication with the shockwave train developing/actuating section, with the gas outlet port adapted to discharge gas in the shockwave train developing/actuating section.

3. The shockwave-actuated power device as claimed in claim 1, further comprising: a gas guiding tube in communication with the chamber, with the gas guiding tube including two ends respectively forming a gas guiding port and a gas inlet port, with the gas guiding port adapted to guide the gas at a side of the piston assembly out of the chamber, with the gas inlet port adapted to fill the gas in the gas guiding tube into another side of the piston assembly.

4. The shockwave-actuated power device as claimed in claim 1, with each of the first and second partitioning members including at least one opening, with the at least one opening of the first partitioning member misaligned from the at least one opening of the second partitioning member.

5. The shockwave-actuated power device as claimed in claim 1, with the first partitioning member including a plurality of openings, with the second partitioning member including an opening, with the opening of the second partitioning member misaligned from the plurality of openings of the first partitioning member and located between two adjacent openings of the first partitioning member.

6. The shockwave-actuated power device as claimed in claim 1, with the piston assembly including a piston and a connecting rod including an end connected to the piston, with the connecting rod including another end extending in a longitudinal direction of the cylinder through an end wall of the cylinder and connected to the power output device.

7. The shockwave-actuated power device as claimed in claim 3, with the piston assembly including a piston and a connecting rod including an end connected to the piston, with the connecting rod including another end extending in a longitudinal direction of the cylinder through an end wall of the cylinder and connected to the power output device.

8. The shockwave-actuated power device as claimed in claim 7, with the piston dividing the shockwave train developing/actuating section into an actuation section and a gas refilling section, with the actuation section being in communication with the gas guiding port of the gas guiding tube, with the gas refilling section being in communication with the gas inlet port of the gas guiding tube and the gas outlet port of the cylinder.

9. The shockwave-actuated power device as claimed in claim 6, with the power output device including a crankshaft, two smaller flywheels and two larger flywheels, with each of the two smaller flywheels connected to one of two ends of the crankshaft, with each of the two smaller flywheels driving one of the two larger flywheels to rotate.

10. A shockwave-actuated power device comprising:
a cylinder including a chamber and a filling port in communication with the chamber;
two regulating modules each including first and second partitioning members and a driving member, with the first and second partitioning members of each of the two regulating modules received in the chamber, dividing the chamber into a high-pressure filling section, two high-energy shockwave producing sections, and two shockwave train developing/actuating sections, with each of the two high-energy shockwave producing sections located between the high-pressure filling section and one of the two shockwave train developing/actuating sections, with the filling port located in the high-pressure filling section, with the driving members of the two regulating modules driving the first and second partitioning members to control communication between the high-pressure filling section, the two high-energy shockwave producing sections, and the two shockwave train developing/actuating sections; and
two piston assemblies, with each of the two piston assemblies movably received in one of the two shockwave train developing/actuating sections, with the two piston assemblies driving a power output device.

11. A shockwave-actuated power device comprising:
two cylinders, with each of the two cylinders including a chamber and a filling port in communication with the chamber;
four regulating modules, with each of the four regulating modules including first and second partitioning members and a driving member, with the first and second partitioning members of each two of the four regulating modules received in the chamber of one of the two cylinders, dividing the chamber of each of the two cylinders into a high-pressure filling section, two high-energy shockwave producing sections, and two shockwave train developing/actuating sections, with each of the two high-energy shockwave producing sections located between the high-pressure filling section and one of the two shockwave train developing/actuating sections, with the filling port located in the high-pressure filling section, with the driving members of each two of the four regulating modules driving the first and second partitioning members to control communication between the high-pressure filling section, the two high-energy shockwave producing sections, and the two shockwave train developing/actuating sections; and
four piston assemblies, with each of the four piston assemblies movably received in one of the two shockwave train developing/actuating sections, with the four piston assemblies driving a power output device.

12. The shockwave-actuated power device as claimed in claim 11, with the high-pressure filling sections of the two cylinders connected to a common high pressure tank, with the high-energy shockwave producing section of each of the two cylinders connected to the common high pressure tank by a filling pipe.
